(19) United States
(12) Patent Application Publication
(10) Pub. No.: US 2021/0267109 A1
(43) Pub. Date: Sep. 2, 2021

(54) METHODS AND APPARATUS FOR YARD AND GARDEN DEBRIS COLLECTION

(71) Applicant: Daniel O'Keefe, Jefferson Valley, NY (US)

(72) Inventor: Daniel O'Keefe, Jefferson Valley, NY (US)

(21) Appl. No.: 17/173,265

(22) Filed: Feb. 11, 2021

Related U.S. Application Data
(60) Provisional application No. 62/982,464, filed on Feb. 27, 2020.

(51) Int. Cl. A01B 1/04; B08B 1/00; B08B 13/00; A01D 11/06

(52) U.S. Cl. CPC A01B 1/04; A01D 11/06; B08B 13/00; B08B 1/005

(57) ABSTRACT

Methods and apparatus for improved yard and garden maintenance are disclosed. The yard and garden maintenance include manual and powered leaf and debris cleaning systems some incorporating specialized fork and teeth designs. In some examples, the powered leaf and debris cleaning systems may include processors, navigation and communications capability.

### CROSS REFERENCE TO RELATED APPLICATION

This application claims the benefit of the U.S. Provisional Application Ser. 62/982,464 filed on Feb. 27, 2020. The contents of which is hereby incorporated by reference.

### FIELD OF THE INVENTION

The present invention relates to methods and apparatus for improved yard and garden maintenance. More specifically the present invention relates to manual and powered leaf and debris plowing systems incorporating specialized fork and teeth designs.

### BACKGROUND OF THE INVENTION

The maintenance of lawn debris can involve large efforts for users of manual equipment such as rakes. Alternatively, power assisted devices such as leaf blowers may also be employed to move the debris. In these cases, large piles of debris may build during the maintenance process. These tools also involve significant labor and stress on an individual operator and particularly place such strains on backs of the user.

Large, powered solutions such as fixtures placed on tractor equipment to vacuum or rake a garden or lawn may improve the conditions of stress on a user but may be expensive and involve significant storage requirements. These large solutions may also create a level of damage and stress to the lawn or garden due to their weight and the design of the tines used to rake the surface to capture and move debris.

It would be useful to have a lower cost, manual or semi-powered device, or a powered device that reduces stress on an operator or and on the lawn and garden being maintained.

### SUMMARY OF THE INVENTION

Accordingly, the present invention provides apparatus and methods for manual, semi-powered and powered debris collection apparatus to supplement or replace other apparatus typically used for yard and garden maintenance. The present disclosure additionally provides methods of using the apparatus of the present invention.

In some embodiments of the present invention, apparatus of the invention is used to clean a surface of debris where the apparatus includes a body comprising a front edge, and an uplifted panel. The uplifted panel entraps debris scooped up by the apparatus. The apparatus may also include at least a first wheel attached to the body; wherein the apparatus moves upon the first wheel with at least a portion of the weight of the body and the entrapped debris supported by the first wheel. The apparatus may also have at least a first fork comprising teeth, wherein the fork is attached to a first adjustment fixture at the front edge of the body. In some examples, the first adjustment fixture attaching the first fork to the front edge of the body may hold the fork at an angle relative to the front edge. In some examples, the angle relative to the front edge uplifts the teeth attached to the fork from a yard surface as the apparatus moves across the yard surface. This apparatus may include examples where the first adjustment fixture attaching the first fork to the front edge of the body is adjustable, wherein an adjustment of the first adjustment fixture modifies the angle of the first fork relative to the front edge. In some examples, the side of the first tooth of the first fork may have a tapered profile. In some examples the end of the first tooth of the first fork has a pointed profile. In other examples, the end of the first tooth of the first fork may have a curved profile.

In some embodiments, at least a first tooth has a rolling feature within a body of the tooth. This rolling feature may include a roughly spherical shaped ball with an axle running through the roughly spherical shaped ball. In other examples, the first tooth of the first fork may be separated from a second tooth of the first fork, and the first tooth may move upon an axle within the fixture independently from the second tooth. In some examples of the apparatus described above the first tooth may have a curved shape under the body of the first tooth, wherein the curved shape under the body of the first tooth facilitates movement across the yard surface by sliding.

In some embodiments of the present invention, the first tooth of the first fork is separated from a second tooth of the first fork, and the first tooth may move upon an axle within the fixture independently from the second tooth.

In another aspect of the present invention, the apparatus may further include a second adjustment fixture, and the second adjustment fixture adjusts a spacing of at least the first wheel from the body.

The apparatus of the present invention may further include a second wheel, a third wheel and a fourth wheel, wherein the second adjustment fixture adjusts a spacing of all of the first wheel, the second wheel, the third wheel and the forth wheel from the body, wherein the adjustment of the spacing changes the elevation of the body over the yard surface.

In some embodiments of the present invention examples, the apparatus may include a handle to facilitate a user to push the apparatus over a yard surface. In some of these examples and in some other examples the apparatus may further include a first motor, wherein at least the first motor provides power to at least the first wheel to facilitate moving the apparatus over a yard surface.

In some embodiments of the present invention, the apparatus may include a battery. In some examples, the apparatus may include a combustion engine. In some examples, the apparatus may include a computer processor, a touch screen interface, and a communication system.

The apparatus of the present invention may include a connection mount, wherein the connection mount connects the apparatus of claim 3 to a motorized tractor or more generally to a motorized frame.

The present invention includes numerous methods that may be practiced with the apparatus of the present disclosure. In an example of a method of cleaning debris from a surface, the method may include steps as follows. Placing an apparatus to clean a surface of debris upon a yard surface, wherein the apparatus to clean a surface of debris comprises a body comprising a front edge, and an uplifted panel, wherein the uplifted panel entraps debris scooped up by the apparatus, at least a first wheel attached to the body; wherein the apparatus moves upon the first wheel with at least a portion of the weight of the body and the entrapped debris supported by the first wheel, at least a first fork comprising teeth, wherein the fork is attached to a first adjustment fixture at the front edge of the body, wherein the first adjustment fixture attaching the first fork to the front edge of the body holds the fork at an angle relative to the front edge, and wherein the angle relative to the front edge uplifts the teeth attached to the fork from a yard surface as the apparatus moves across the yard surface. The method may also include a step of adjusting the first adjustment fixture to place the fork at a different degree of uplift from a yard surface in response to one or more of the length of grass blades, the roughness of the surface, and the nature of the debris upon the yard. The method may also include a step of moving the apparatus across the yard surface, wherein by the moving debris is caught into the body of the apparatus and moved by the apparatus.

In another example of the present invention of a method of cleaning debris from a surface, the method may include placing an apparatus to clean a surface of debris upon a yard surface, wherein the apparatus to clean a surface of debris comprises a body comprising a front edge, and an uplifted panel, wherein the uplifted panel entraps debris scooped up by the apparatus, at least a first wheel attached to the body; wherein the apparatus moves upon the first wheel with at least a portion of the weight of the body and the entrapped debris supported by the first wheel, at least a first fork comprising teeth, wherein the fork is attached to a first adjustment fixture at the front edge of the body, wherein the first adjustment fixture attaching the first fork to the front edge of the body holds the fork at an angle relative to the front edge, wherein the angle relative to the front edge uplifts the teeth attached to the fork from a yard surface as the apparatus moves across the yard surface, a second adjustment fixture to adjust a spacing between the body and the first wheel, a motor to provide power to the first wheel, a computer processor, a touch screen interface, and a communication system.

The method may include another step of adjusting the first adjustment fixture to place the fork at a different degree of uplift from a yard surface in response to one or more of the length of grass blades, the roughness of the surface, and the nature of the debris upon the yard. The method may also include another step of adjusting the second adjustment fixture to change a spacing between the first wheel and the body of the apparatus. The method may also include another step of communicating parameters to the communication system from an external communication device. The method may include another step of inputting the parameters from the communication system into the processor, wherein the parameters are used by the processor to determine a path of movement of the apparatus. The method may also include another step of moving the apparatus across the yard surface, wherein by the moving debris is caught into the body of the apparatus and moved by the apparatus.

One general aspect includes a method of cleaning a debris from a surface. In some examples the method includes placing an apparatus to clean the surface of the debris upon a yard surface. The apparatus to clean the surface of the debris may include a frame which may include a front face. The apparatus may also include an uplifted panel, where the uplifted panel entraps debris scooped up by the apparatus. The apparatus may also include at least a first wheel attached to the frame; where the apparatus moves upon the first wheel with at least a portion of a weight of both the frame and the debris supported by the first wheel. The apparatus may include at least a first fork which may include teeth. In some examples, the first fork is attached to a first adjustment fixture, where the first adjustment fixture holds the first fork at an angle relative to the yard surface. In some examples, the angle relative to the yard surface uplifts the teeth attached to the first fork from the yard surface as the apparatus moves across the yard surface. In some general aspects, the methods also may include adjusting the first adjustment fixture to place the first fork at a different degree of uplift from the yard surface in response to one or more of a length of grass blades, a roughness of the surface, and a nature of the debris upon the yard surface. The method may also include moving the apparatus across the yard surface, where the debris is caught into the uplifted panel of the apparatus and moved by the apparatus.

One general aspect includes a method of cleaning a debris from a surface. The method may include placing an apparatus to clean the surface of the debris upon a yard surface. The method may include examples where the apparatus to clean the surface of the debris may include a drive frame. The method may also include an apparatus with an uplifted panel, where the uplifted panel entraps debris scooped up by the apparatus. The method may include placing an apparatus with at least a first wheel attached to the drive frame; where the apparatus moves upon the first wheel with at least a portion of a weight of the drive frame and the debris supported by the first wheel. The apparatus may also include at least a first fork which may include teeth, where the first fork is attached to a first adjustment fixture. The method may include an apparatus where the first adjustment fixture holds the first fork at an angle relative to the surface, where the angle relative to the yard surface uplifts the teeth attached to the first fork from the yard surface as the apparatus moves across the yard surface. In some examples, the apparatus may also include a second adjustment fixture to adjust a spacing between the drive frame and the first wheel. The apparatus may also include a motor to provide power to the first wheel. The apparatus may also include a computer processor, a touch screen interface, and a communication system. The method may also include adjusting the first adjustment fixture to place the first fork at a different degree of uplift from the yard surface in response to one or more of a length of grass blades, a roughness of the surface, and a nature of the debris upon the yard surface. The method may include adjusting the second adjustment fixture to change the spacing between the first wheel and the drive frame of the apparatus. The method may include communicating parameters to the communication system from an external communication device. The method may include inputting the parameters from the communication system into the computer processor, where the parameters are used by the computer processor to determine a path of movement of the apparatus. The method may include moving the apparatus across the yard surface, where the debris is caught into the uplifted panel of the apparatus and moved by the apparatus. Other embodiments of this aspect include corresponding computer systems, apparatus, and computer programs recorded on one or more computer storage devices, each configured to perform the actions of the methods.

### DESCRIPTION OF THE DRAWINGS

The accompanying drawings, that are incorporated in and constitute a part of this specification, illustrate several embodiments of the invention and, together with the description, serve to explain the principles of the invention:

FIG. 1A illustrates a top view of exemplary apparatus according to the present description.

FIG. 1B illustrates a side view of exemplary apparatus according to the present description.

FIGS. 2A-2C illustrate examples of different fork and tine designs according to the present description.

FIGS. 3A-3C illustrates examples of height adjustment components of exemplary apparatus according to the present description.

FIGS. 4A-4B illustrates exemplary power assist wheel drive apparatus according to the present description.

FIG. 4C illustrates an exemplary adjustable elevating and pivoting assembly according to the present description.

FIG. 5 illustrates a general processor design as used in the present description.

FIG. 6 illustrates a general smart/mobile device design as used in the present description.

FIG. 7A-7D illustrate exemplary method steps for using the apparatus of the present description.

### DETAILED DESCRIPTION

The present invention provides an improved apparatus for the collection or relocation of yard and garden debris during maintenance. Various examples of the present invention may be generically called a “Leaf Caddy” as a descriptor of related apparatus. A Leaf Caddy in its fundamental form may comprise a set of one or more wheels that support a frame with tines positioned in a forward portion of the frame. The one or more wheels support the bulk of the weight of the apparatus removing such burden from an operator who is performing lawn and garden maintenance. In an example, an operator may push the Leaf Caddy over a garden surface and the frame of the device may receive debris caught into its structure by the tines as they move over a garden surface that has debris upon it. In some examples, the debris may include one or more of leaves, twigs, fruits, nuts and other such debris. By catching the debris, the apparatus may allow the user to collect the debris and move it to a desired location. The designs improve upon current manual apparatus such as rakes because the weight of the apparatus and collected debris is supported upon a wheelbase to the ground.

An important aspect of a Leaf Caddy may be the design of the tines and how the tines are deployed. In a preferred example, the tines may sit on the front of the device and be positioned such that the tines point in an upward direction. The upward direction may be relative to the surface that the device rolls upon. The degree of upward tilt may be fixed upon manufacture or may have an adjustment capability as is described in following sections.

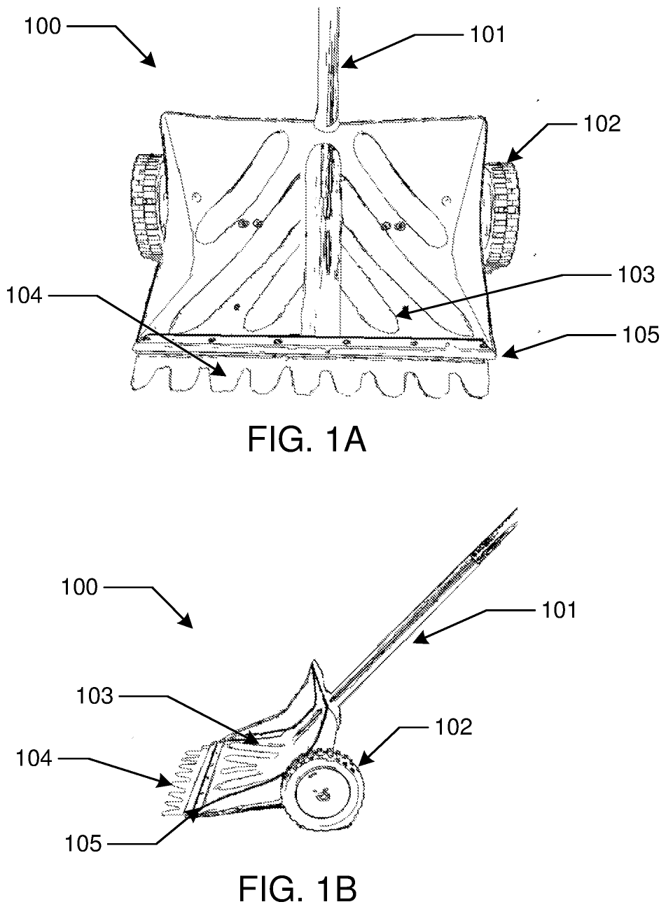

In a base example, a Leaf Caddy may comprise a set of two wheels and be pushed by an operator holding a handle that projects upwards from the main body of the device. Referring to FIG. 1A an illustration of an example of a Leaf Caddy 100 is provided. The Leaf Caddy 100 may include a handle 101 for an operator to push the device. The handle 101 may be formed of solid materials such as wood, fiber based materials, metals, plastics or combinations of these. Other materials may be used so long as the resulting material or composite of materials provides a strong and, in preferred examples, light weight support for manually moving the device. The top portion may include a grip or a handle to assist positive holding by the user and to support a lifting motion if used. In some examples, different handle types may be placed or replaced on the device as an optional accessory. In an example, a handle may be a straight pole with a non-slip plastic grip affixed at the end.

The Leaf Caddy, 100 may have a set of wheels 102 that are affixed upon the body of the device. There may be numerous designs of the type of tire and the surface texture or “treads” that the wheels are formed into. In an example, Turf treads, which may be most common may have circumferential rows of chevron shaped tread blocks. These may provide a degree of traction on slick grass, while not digging up and damaging the turf. In another example, knobby, all-terrain treads may be used which may typically have large tread blocks and deeper grooves to provide traction in loose surfaces like dirt, sand or mud. In some examples knobby tires may have a herringbone tread pattern, such as may be observed on large devices such as a farm tractor. The knobby feature may have a high void area between the knobs to evacuate debris from the tire. In another example, ribbed treads have circumferential grooves and straight ribs that are either flat or slightly scalloped which may provide long life and a combination of aspects of turf and knobby tires. In some examples, the tires may be replaceable.

### Leaf Caddy

In the illustrated example in FIGS. 1A and 1B, two wheels are employed for the device, but single wheel devices (with ball or spherical shaped tires) or devices with more than two tires are also consistent with the present description. In some examples these wheels may be rigidly affixed around a single axle and rotate on the axle. In other examples, the wheels may have ability to rotate around a point to assist in steering capability. Here as well, common tire materials may be employed for various design examples; however, it may be preferred that the resulting tires are as lightweight as possible. In some examples, a solid tire may be used; whereas, in other examples a hollow tire which may be inflated and may include an inner tube may be used.

In some examples, the wheels 102 may be located outboard of the body 103 of the leaf caddy 100. In other examples, they may be located underneath and within the extents of the body. In such an example, the tires are riding upon a portion of a lawn or garden surface where the leaf caddy has picked up debris by its action.

The Leaf Caddy 100 may include a body 103 of the device. There may be numerous shapes consistent with a Leaf Caddy 100, but a shape which includes a sloping front edge with attached teeth of fork 104 along the front may be preferred. In some examples, the sloping front edge may rise up to create a volume to catch debris in. In some examples, the structure of the attached teeth of the fork 104 may be affixed to the body 103 of the device with a hinge 105. The hinge 105 may allow for the teeth of the fork 104 to flexibly rotate to a degree as the leaf caddy 100 is pushed across a lawn or garden surface which may have topographic rises and falls.

### Fork and Teeth Designs

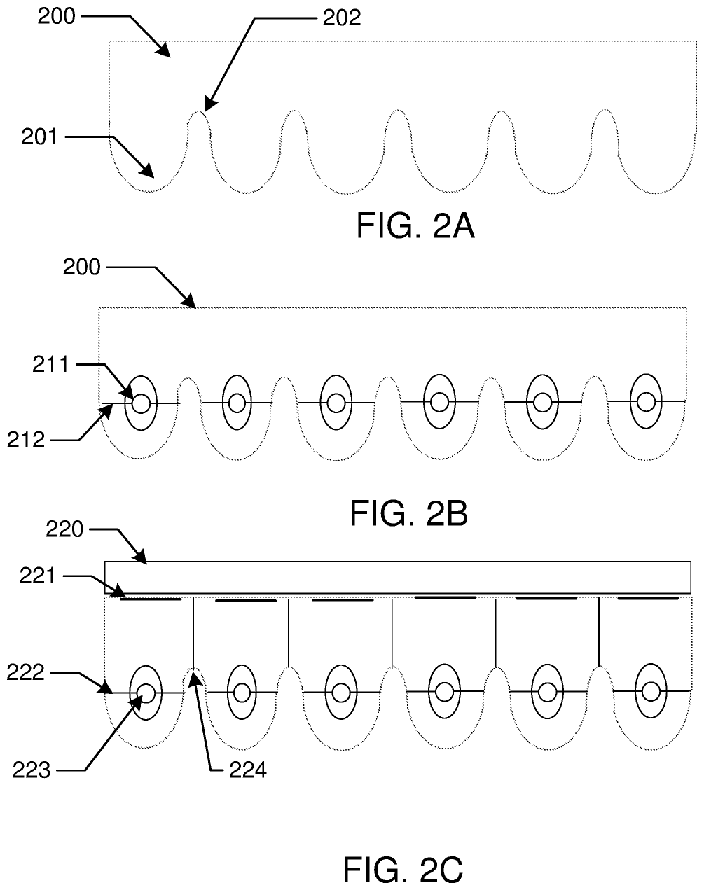

Referring to FIG. 2A, a “fork” 200, which may be a combination of teeth, may include a single piece of material with cut outs to shape a linear deployment of teeth. In a specific example, teeth 201 of the device may be shaped as illustrated which may be termed finger type teeth that are one inch in diameter and rounded 180 degrees at the tip, other dimensions and shapes are possible. The teeth may be separated, as an example, 2 inches from center leaving a shape 202 between the teeth. In the example, the shape 202 may be rounded. In other examples angular intersections or more complicated shapes may be used. In some examples, the teeth may also have a curve of uniform or variable arc upward towards the tip with a protruding under belly. Various three dimensional shapes may be employed for different operational needs such as the type of grass, the type of soil, the prevalence of exposed tree roots and the like. In many examples, a design goal of the design of the shape of the teeth may be the elimination of the likelihood of the tips digging into the surface of the garden or law and the device is moved across it.

In some examples, the body 103 of the leaf caddy in the region just next to the fork including the teeth may include a small roller type wheel. The roller wheel may be a one half inch diameter roller wheel, which may assist in keeping the teeth in the fork position at a fixed position above the surface. The maintenance of this separation from the surface enables effective capture of debris such as leaves and twigs.

In an alternative embodiment of the present invention, illustrated in reference to FIG. 2B, each of the teeth 201 of a fork 200 may include a roller ball. In an example, a cutout in each tooth may allow a rotating structure such as a ball 211 or a wheel to be mounted on an axle 212. The axle may be rigid and affixed to the fork/teeth material in some examples. In other examples of the present invention, the axle may be flexible allowing the ball a degree of flexibility in its position. In some examples, the balls may be a common dimension and shape for all teeth. In other examples, up to each (one up to all) of the balls may have unique characteristics such as their design, shape, texture, material composition and the like. In some examples, the balls may be replaced with rotating brushes that also support the tooth at a height above the surface. If the brushes are affixed upon a common rotating axle, a motive force may be applied to the axle to cause the brushes to rotate against the direction that they would move normally and provide a sweeping action as the leaf caddy moves forward.

In a further example, illustrated in FIG. 2C, each tooth may have a rotating structure such as a ball 223 as described above held in place by an axle 222. However, each tooth in the fork may be cut apart from its neighbors. A separation 224 between each of the teeth may allow for each tooth to flexibly move depending on the local topography of the lawn or garden surface under it. The segregated teeth may each be affixed at a hinge point 221 which may attach to the body 103 of the leaf caddy or to an exterior portion 220 of the fork 200. When the hinges of the teeth are affixed to an exterior portion 220 of the fork 200, this allows the angle of the fork to be adjustable as a whole for all teeth, where the separated teeth may have a degree of flexibility to move around that global angle. The hinge point 221 may include components such as spring or flaps that act like spring which may tend to force the teeth in a certain direction relative to the surface. In an example, springs may push the individual teeth down upon the surface, where the rolling ball 223 may maintain the tooth body at a certain height over the portion of the lawn surface directly under the teeth.

The various fork and teeth examples may have feature aspects that allow for facilitated replacement of subsections of the caddy structure. In some examples, an entire fork of teeth may be replaceable. The fork may slide into a slot on a body of the uplifted panel of the caddy. There may be attachment features such as various types of hardware including screws, rivets, snaps and the like to affix the fork to the panel. In other examples, the individual teeth may be replaceable. In a non-limiting example, in examples with hinges the hinge may be separable to allow for a facilitated replacement component aspect. In some examples, there may be sliding features underneath one or more teeth, which may be subjected to more wear than the teeth themselves. Accordingly, the ability to change individual teeth may allow for a replacement strategy for wear of the sliders located underneath teeth.

### Height Adjustments

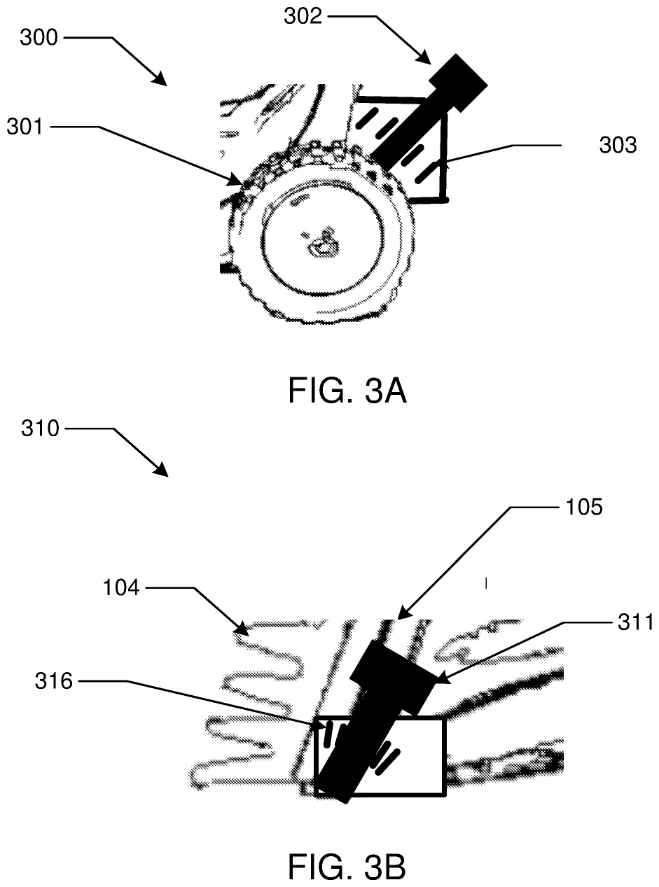

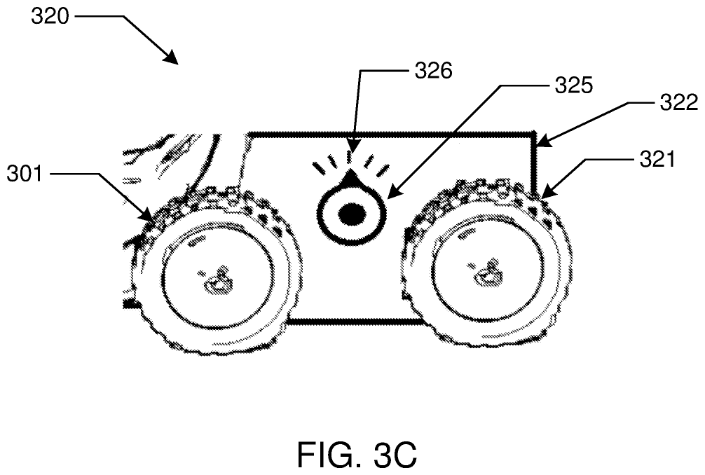

Referring now to FIG. 3A, item 300, an exemplary height adjustment component is illustrated. The height and, in some examples, angle of the fork 200 in the front of the leaf caddy 100 may be adjusted by adjusting the center of a wheel to its attachment point on the body 103 of the leaf caddy 100. In examples with wheels 301 directly fastened to the body 103 of the leaf caddy 100, an adjustment level 302 may be moved to various locations 303 and in so moving may adjust the height of the wheel 301 relative to the body 103 of the leaf caddy. Numerous other designs for height adjustment such as but not limited to adjustment screws, and different attachment points for the wheels may also be employed.

The angle of the teeth of the fork 104 may be adjusted with added components as well. Referring to FIG. 3B, item 310, an example of an adjustment component that may rotate the teeth of the fork 104 with respect to its attaching hinge 105 is illustrated. In an example, an affixed lever 311 may be rotated around the axis of the hinge 105 to hold the fork 104 at an adjusted angle. There may be numerous adjustment points 316 that the lever may be moved to and locked down to position the fork 104 into a desired angle relative to the body of the leaf caddy. There may be numerous other manners to adjust the angle of the fork 104 including in a non-limiting sense a locking screw on the end of the hinge axis.

In another example illustrated in FIG. 3C, item 320, a leaf caddy 100 may be attached to a four wheeled structure. Thus, in addition to the two wheels, where one wheel 301 is illustrated in the side view, two additional wheels, where the location is shown with an additional wheel 321, is also illustrated in the side view of FIG. 3C, may be attached to a structure 322. Inside the structure 322 there may be components that allow for the wheels, 301 and 311 and their corresponding paired wheels to be adjusted relative to the structure 322 to which the leaf caddy body 103 may be attached. An adjustment component 325 may allow a movement of its dial to cause this relative movement of the center points of the wheels to the structure 322. There may be numerous setpoints 326 which may set various height relationships of the forks to the surface of the yard or garden. Such height adjustments may be important for numerous aspects such as, in a non-limiting sense, the height of the grass in a yard, the nature of the debris, a particular design of a fork/teeth, a type of wheel attached to the structure and the like. In some examples, the adjustment component 325 may send an electrical signal that causes the components within the structure 322 to adjust the height by motorized means such as a motor rotating a screw attached to positioning elements of the height.

### Powered Design Options

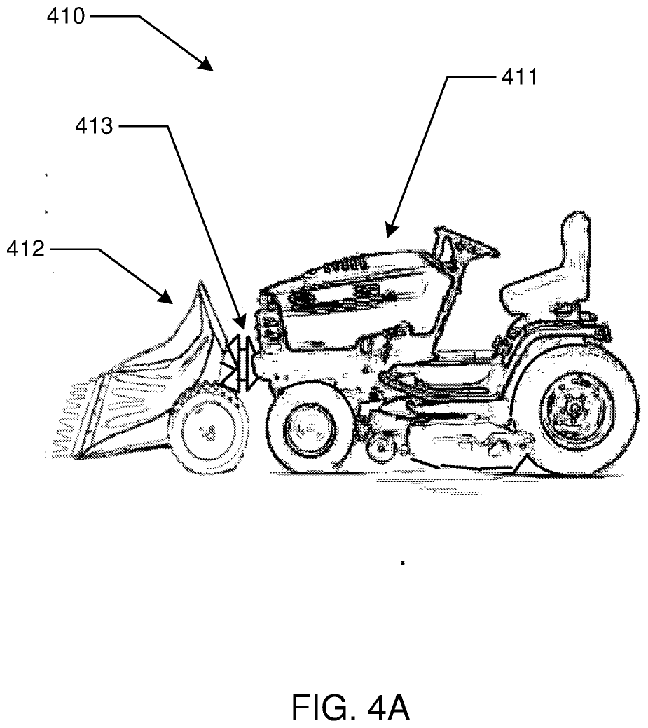

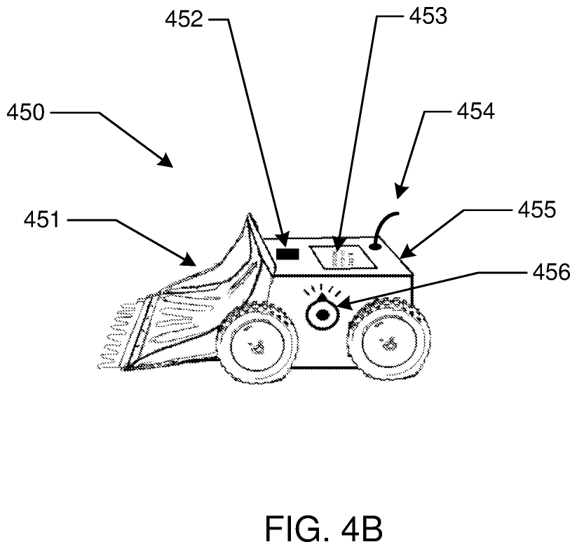

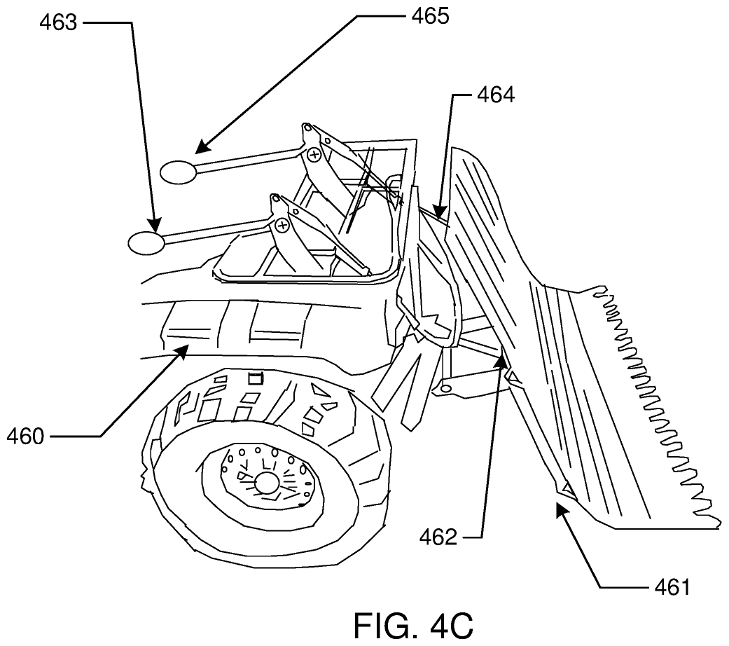

A version of the leaf caddy may be created that may be affixed to a tractor, a riding lawn mower, an all-terrain vehicle (ATV) or other powered conveyance. With all the different aspects that have been described including control over the angle of teeth protruding in the front of a pushing body, the leaf caddy may have powered aspects. Referring to FIG. 4A, item 410, a leaf caddy 412, which may be scaled to be larger than a manual design, may be attached to a tractor 411. An attachment point 413 may hold the leaf caddy to the tractor. In some examples, the leaf caddy may include its own wheel as has been illustrated in FIG. 4A, item 410. In other examples it may just be fixed to the body of the tractor 411. The attachment point 413 may be a fixed plate in some examples. In other examples, the attachment point 413 may be more of a coupling allowing the leaf caddy to be placed onto the attachment point, such as with a set of hooks on one side overlapping a bar on the other side and having a locking fixture to hold it in place. In still further examples, the attachment point may include a flexing capability, with springs and shocks that may lock the leaf caddy in place but allow some movement to occur when the surface topography of the lawn or garden varies and puts stress onto the leaf caddy.

In another example, referring back to FIG. 3C, one or more of the front wheels 301 and/or the back wheels 321 may be attached with a motorized assist unit. The motorized assist unit may take a power source and use a motor to assist the movement of the leaf caddy. Numerous types of power source of power assisted movement may be adapted to the leaf caddy. In some examples, a portable battery pack such as a lithium ion battery pack, may power an electric motor. There may be many operating voltages that a battery pack may provide, and in an example, twenty four volt nominal battery packs may be employed. Charging for the battery packs may be performed by attaching a power source to the leaf caddy body in some examples. In other examples, the battery pack may be removable, and a removed battery pack may be charged with an AC adapter.

In other examples, an internal combustion engine may be employed to power a transmission to provide power to the wheels directly. In other examples, an internal combustion engine may be used to run a generator/alternator to produce electric power which may be stored on a battery pack and ultimately used to power the motor. In still further examples, a corded application where a power cord is attached to an AC outlet and trails along with the leaf caddy may be used.

In another example, referring to FIG. 4B a power assisted leaf caddy 450 may be configured to operate as an autonomous or wirelessly guided unit. A leaf caddy body 451 may be attached to a structure 455 which may house power units and motor assist units as have been discussed previously. The various tire and wheel systems may be driven by the motor assist units to move the device around a law or a garden surface. The unit may include a removable battery unit 452 in some examples. In other examples, other power supplies including hard mounted battery units, combustion engines and corded supplies may be used. The power assisted leaf caddy 450 may include various data processing elements 453 which may include I/O devices such as touch screen displays to provide feedback to a user and to allow for interaction with the data processing elements 453.

External buttons 456 and other such devices may also be used to provide input to the data processing elements 453 and to establish operating parameters of the device. The unit may wirelessly communicate through a communication system 454 with controlling systems such as handheld wireless “joystick” systems, with smart devices such as a mobile phone of a user, or with cellular based communications systems or with WiFi based systems operating on smart devices, computers or server based systems. The device may operate software programs that perform a variety of functions such as facilitating the navigation of the device including determining the leaf caddy's location, sensing performance, and reading sensor readings within the device such as sensing communications from buried elements in a yard in which the device operates where those communications signal a perimeter of the region that an autonomous leaf caddy may operate in, planning a path to operate the leaf caddy on and the like.

In another example, referring to FIG. 4C, the leaf caddy frame 461 may be supported to body hardware of an ATV 460. There may be adjustment fixtures, such as height adjustment 462 that may lift the leaf caddy frame 461. In some examples, a lever 463 may be used to select between a first upper position and a second lower and engaged position. In other examples, there may be multiple levels of adjustment. In still further examples, a locking mechanism ma be used to hold an arbitrary position between a fully uplifted position and a fully lowered position. The actuation of the adjustment may be performed manually, as is illustrated, or with motorized capabilities.

Continuing with FIG. 4C, as well, there may be an angle adjustment control such as the manual lever 464 that may be used to adjust the angle that the leaf caddy frame 461 assumes relative to the body of the ATV. In some examples, a manual lever 464 may move a fixture attached to the leaf caddy frame 461 and cause it to pivot around an attachment axle. In some examples, a lever 465 may be used to facilitate the adjustment of the angle setting. As with the height adjustment there may be manual and automated manners to set the adjustment of the angle setting. There may be numerous manners to allow for a change of the angle of the leaf caddy frame 461.

### As a Supplement to Other Tools

The various examples of a leaf caddy may be employed to assist a user in the performance of maintenance of yards and garden with debris upon them. The device may be used to push such debris into piles or to push the debris into a region where it may reside. The leaf caddy may be used in conjunction with other yard cleaning devices of a user. For example, a manually operated version of a leaf caddy may offer a time cutting solution for a user who is using a blower to create piles of leaves in a yard or garden.

For some leaf blowing units such as handheld, backpack or small rolled leaf blowers, piles of leaves may build up that are difficult to keep moving with a leaf blower. In such a case, the user with the blower may employ the leaf caddy to move the pile to a desired location and then resume operations with the leaf blower. Other such supplemental use of the leaf caddy with other tools may naturally be employed. An autonomous leaf caddy may be programmed to operate on a routine schedule where the schedule is designed to correspond with an amount of leaves or other debris that the leaf caddy may routinely deal with. Thus, after a leaf caddy performs such a routine schedule, a user may have an easier job to clean up a yard with a rake, leaf blower, vacuum or other yard cleaning tool as a supplement to the leaf caddy.

### Processors

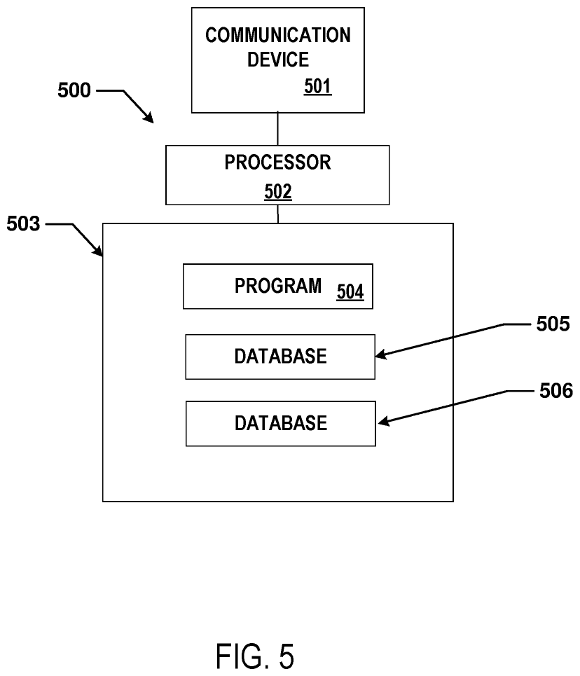

Referring now to FIG. 5 an automated controller is illustrated that may be used to implement various aspects of the present invention. The controller may be integrated within an exemplary leaf caddy type device to control systems such as a drive system to move the device. The controller 500 includes a processor unit 502, such as one or more semiconductor based processors, coupled to a communication device 501 configured to communicate via a communication network (not shown in FIG. 5). The communication device 501 may be used to communicate, for example, with one or more online devices, such as a personal computer, laptop, or a handheld device.

The processor 502 is also in communication with a storage device 503. The storage device 503 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 503 can store a software program 504 with executable logic for controlling the processor 502. The processor 502 performs instructions of the software program 504, and thereby operates in accordance with the present invention. The processor 502 may also cause the communication device 501 to transmit information, including, in some instances, control commands to operate apparatus to implement the processes described above. The storage device 503 can additionally store related data in a database 505 and database 506, as needed.

### Smart/Mobile Devices

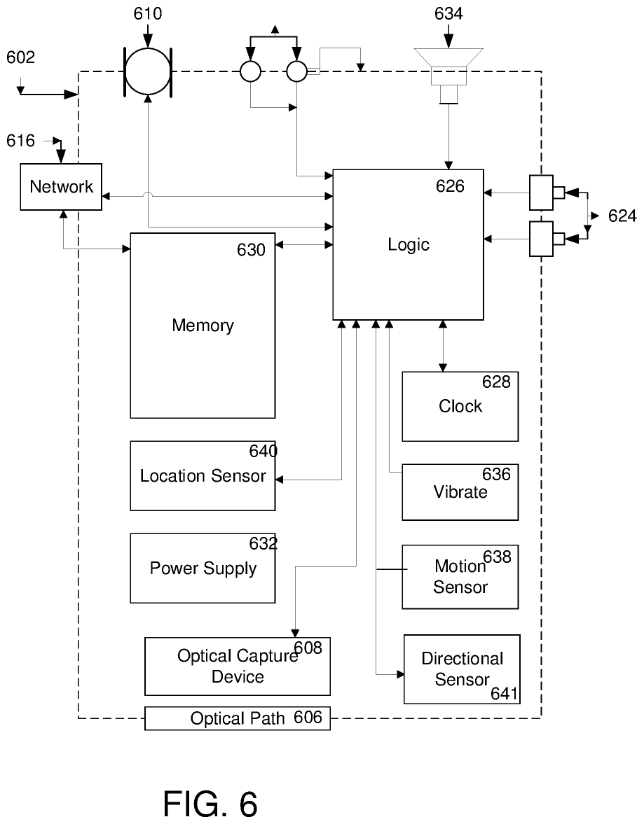

Referring now to FIG. 6, a block diagram of an exemplary mobile device 602 is presented. These devices may be used in some examples to control an autonomous/powered device capable of receiving signals via WiFi, Bluetooth or Cellular protocols. The mobile device may include a display screen that can present data related to communications with a powered leaf caddy. The mobile device 602 comprises an optical capture device 608 to capture an image and convert it to machine-compatible data, and an optical path 606, typically a lens, an aperture or an image conduit to convey the image from the rendered document to the optical capture device 608. The optical capture device 608 may incorporate a Charge-Coupled Device (CCD), a Complementary Metal Oxide Semiconductor (CMOS) imaging device, or an optical Sensor 624 of another type.

A microphone 610 and associated circuitry may convert the sound of the environment, including spoken words, into machine-compatible signals. Input facilities may exist in the form of buttons, scroll wheels, or other tactile Sensors such as touch-pads. In some embodiments, input facilities may include a touchscreen display.

Visual feedback to the user is possible through a visual display, touchscreen display, or indicator lights. Audible feedback 634 may come from a loudspeaker or other audio transducer. Tactile feedback may come from a vibrate module 636.

A motion Sensor 638 and associated circuitry convert the motion of the mobile device 602 into machine-compatible signals. The motion Sensor 638 may comprise an accelerometer that may be used to sense measurable physical acceleration, orientation, vibration, and other movements. In some embodiments, motion Sensor 638 may include a gyroscope or other device to sense different motions.

A location Sensor 640 and associated circuitry may be used to determine the location of the device. The location Sensor 640 may detect Global Position System (GPS) radio signals from satellites or may also use assisted GPS where the mobile device may use a cellular network to decrease the time necessary to determine location. In some embodiments, the location Sensor 640 may use radio waves to determine the distance from known radio sources such as cellular towers to determine the location of the mobile device 602. In some embodiments these radio signals may be used in addition to GPS.

The mobile device 602 comprises logic 626 to interact with the various other components, possibly processing the received signals into different formats and/or interpretations. Logic 626 may be operable to read and write data and program instructions stored in associated storage or memory 630 such as RAM, ROM, flash, or other suitable memory. It may read a time signal from the clock unit 628. In some embodiments, the mobile device 602 may have an on-board power supply 632. In other embodiments, the mobile device 602 may be powered from a tethered connection to another device, such as a Universal Serial Bus (USB) connection.

The mobile device 602 also includes a network interface 616 to communicate data to a network and/or an associated computing device. Network interface 616 may provide two-way data communication. For example, network interface 616 may operate according to the internet protocol. As another example, network interface 616 may be a local area network (LAN) card allowing a data communication connection to a compatible LAN. As another example, network interface 616 may be a cellular antenna and associated circuitry which may allow the mobile device to communicate over standard wireless data communication networks. In some implementations, network interface 616 may include a Universal Serial Bus (USB) to supply power or transmit data. In some embodiments other wireless links may also be implemented.

As an example of one use of mobile device 602, a reader may scan some coded information from a location marker in a facility with the mobile device 602. The coded information may include for example a hash code, bar code, RFID or other data storage device. In some embodiments, the scan may include a bit-mapped image via the optical capture device 608. Logic 626 causes the bit-mapped image to be stored in memory 630 with an associated time-stamp read from the clock unit 628. Logic 626 may also perform optical character recognition (OCR) or other post-scan processing on the bit-mapped image to convert it to text. Logic 626 may optionally extract a signature from the image, for example by performing a convolution-like process to locate repeating occurrences of characters, symbols or objects, and determine the distance or number of other characters, symbols, or objects between these repeated elements. The reader may then upload the bit-mapped image (or text or other signature, if post-scan processing has been performed by logic 626) to an associated computer via network interface 616.

As an example of another use of mobile device 602, a reader may capture some text from an article as an audio file by using microphone 610 as an acoustic capture port. Logic 626 causes audio file to be stored in memory 630. Logic 626 may also perform voice recognition or other post-scan processing on the audio file to convert it to text. As above, the reader may then upload the audio file (or text produced by post-scan processing performed by logic 626) to an associated computer via network interface 616.

A directional sensor 641 may also be incorporated into the mobile device 602. The directional device may be a compass and be based upon a magnetic reading or based upon network settings.

### Methods Related to a Leaf Caddy

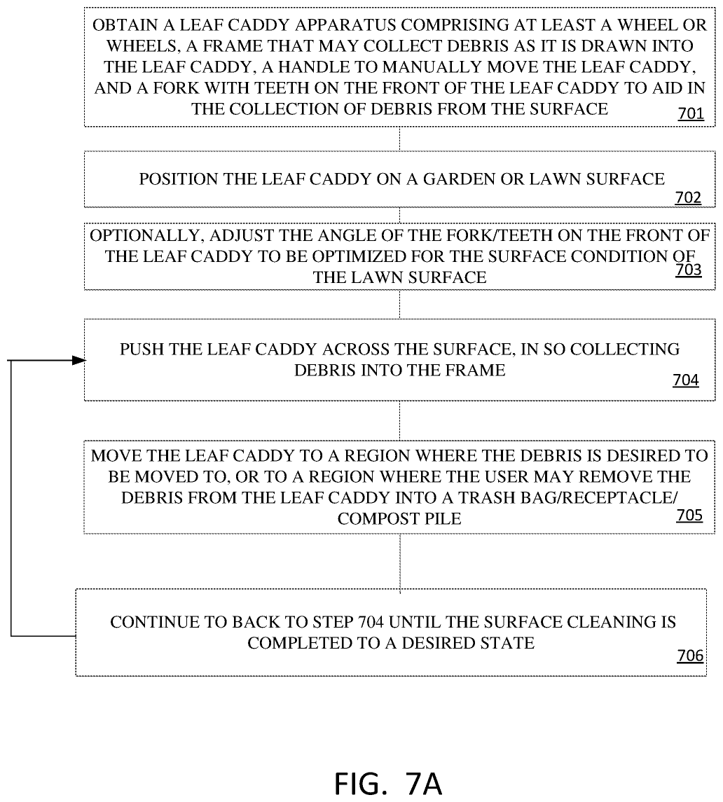

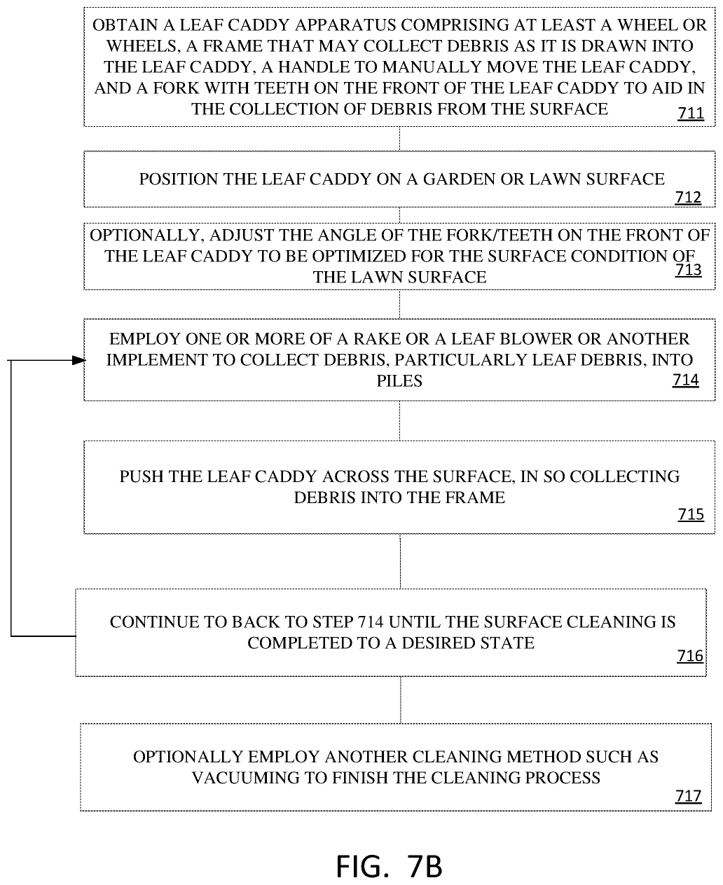

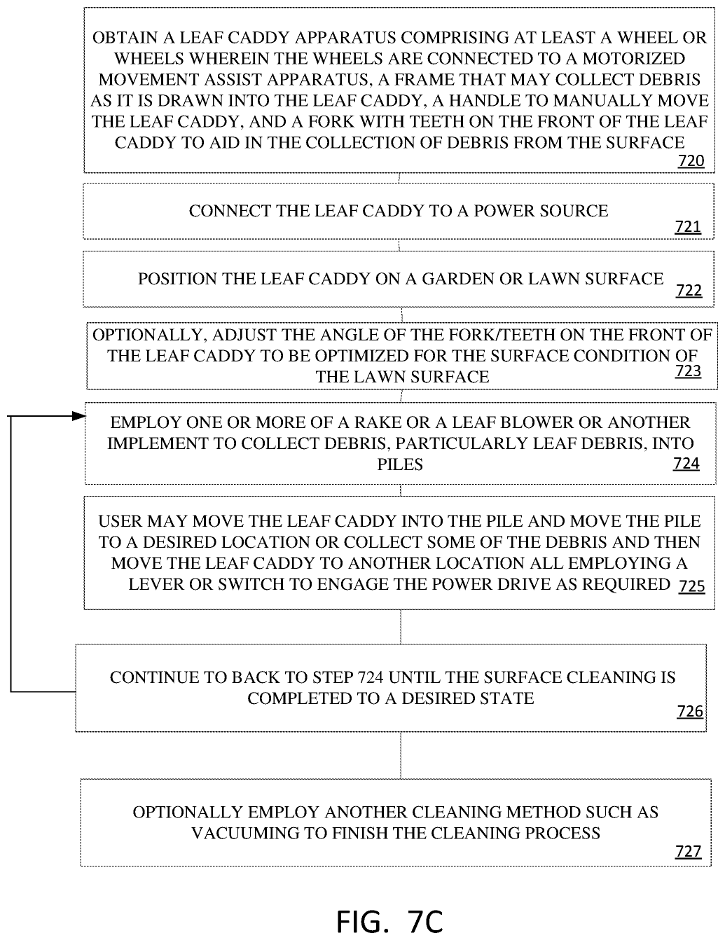

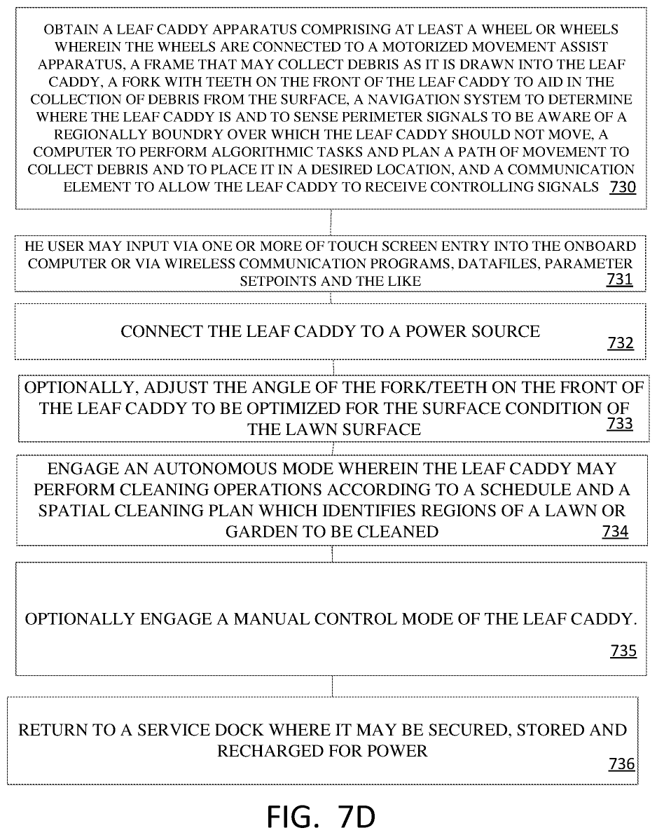

Numerous methods may be executed during operation of a leaf caddy. In a first method, and referring to FIG. 7A, a leaf caddy may be used to clean a lawn or garden surface of debris. At step 701, a user may obtain a leaf caddy apparatus comprising at least a wheel or wheels, a frame that may collect debris as it is drawn into the leaf caddy, a handle to manually move the leaf caddy, and a fork with teeth on the front of the leaf caddy to aid in the collection of debris from the surface. Next at step 702, a user may position the leaf caddy on a garden or lawn surface. At step 703, an optional step may be performed to adjust the angle of the fork/teeth on the front of the leaf caddy to be optimized for the surface condition of the lawn surface. In other examples, the fork may be permanently angled on manufacture to be optimal for normal surface conditions. At step 704, the user may push the leaf caddy across the surface, in so collecting debris into the frame. At step 705, the user may move the leaf caddy to a region where the debris is desired to be moved to, or to a region where the user may remove the debris from the leaf caddy into a trash bag/receptacle/compost pile. At step 706, the user may continue to back to step 704 until the surface cleaning is completed to a desired state.

Referring to FIG. 7B, an alternative method is depicted. At step 711, a user may obtain a leaf caddy apparatus comprising at least a wheel or wheels, a frame that may collect debris as it is drawn into the leaf caddy, a handle to manually move the leaf caddy, and a fork with teeth on the front of the leaf caddy to aid in the collection of debris from the surface. Next at step 712, a user may position the leaf caddy on a garden or lawn surface. At step 713, an optional step may be performed to adjust the angle of the fork/teeth on the front of the leaf caddy to be optimized for the surface condition of the lawn surface. At step 714, a user may employ one or more of a rake or a leaf blower or another implement to collect debris, particularly leaf debris, into piles. In some examples, the growth of the piles may make the collection process continually more difficult. At step 715, a user may push a leaf caddy into the pile and move the pile to a desired location or collect some of the debris and then move it to another location. At step 716, after reducing or eliminating the piles with the leaf caddy, a user may again employ one or more of a rake or a leaf blower to clean the surface. At step 717, a user may optionally employ a vacuum to collect any small amount of debris remaining from the processing.

Referring now to FIG. 7C, a user may employ power assist to move a leaf caddy. At step 720, a user may obtain a leaf caddy apparatus comprising at least a wheel or wheels wherein the wheels are connected to a motorized movement assist apparatus, a frame that may collect debris as it is drawn into the leaf caddy, a handle to manually move the leaf caddy, and a fork with teeth on the front of the leaf caddy to aid in the collection of debris from the surface. At step 721, the user may connect the leaf caddy to a power source, wherein the connection may either charge batteries within the leaf caddy or directly provide power through an electric cord. Or, in some examples, a fuel powered engine may provide one or more of electrical power to charge batteries or mechanical power to assist the wheels. Next at step 722, a user may position the leaf caddy on a garden or lawn surface employing a lever or switch to engage the power drive as required. At step 723, an optional step may be performed to adjust the angle of the fork/teeth on the front of the leaf caddy to be optimized for the surface condition of the lawn surface. At step 724, a user may employ one or more of a rake or a leaf blower or another implement to collect debris, particularly leaf debris, into piles. In some examples, the growth of the piles may make the collection process continually more difficult. At step 725, a user may move the leaf caddy into the pile and move the pile to a desired location or collect some of the debris and then move the leaf caddy to another location all employing a lever or switch to engage the power drive as required. At step 726, after reducing or eliminating the piles with the leaf caddy, a user may again employ one or more of a rake or a leaf blower to clean the surface. At step 727, a user may optionally employ a vacuum to collect any small amount of debris remaining from the processing. For examples where a leaf caddy is attached to a power system such as a mower unit, a user may get an advantage of pushing the debris away into piles or onto the periphery while at the same time mowing and cleaning any materials that remain after the leaf caddy apparatus passes over the yard or garden surface.

Referring now to FIG. 7D, a user may employ an autonomous or semi-autonomous leaf caddy. At step 730, a user may obtain a leaf caddy apparatus comprising at least a wheel or wheels wherein the wheels are connected to a motorized movement assist apparatus, a frame that may collect debris as it is drawn into the leaf caddy, a fork with teeth on the front of the leaf caddy to aid in the collection of debris from the surface, a navigation system to determine where the leaf caddy is and to sense perimeter signals to be aware of a regionally boundary over which the leaf caddy should not move, a computer to perform algorithmic tasks and plan a path of movement to collect debris and to place it in a desired location, and a communication element to allow the leaf caddy to receive controlling signals. At step 731, the user may input via one or more of touch screen entry into the onboard computer or via wireless communication programs, datafiles, parameter setpoints and the like. At step 732 the user may connect the leaf caddy to a power source, wherein the connection may either charge batteries within the leaf caddy or directly provide power through an electric cord. Or, in some examples, a fuel powered engine may provide one or more of electrical power to charge batteries or mechanical power to assist the wheels. At step 733, the user may optionally adjust the angle of the fork/teeth on the front of the leaf caddy to be optimized for the surface condition of the lawn or garden surface. At step 734, a user may engage an autonomous mode wherein the leaf caddy may perform cleaning operations according to a schedule and a spatial cleaning plan which identifies regions of a lawn or garden to be cleaned. At step 735, the user may optionally engage a manual control mode of the leaf caddy that may be controlled via a wireless transceiver such as on a game controller or with a smart phone or other device. At step 736, the leaf caddy may return to a service dock where it may be secured, stored and recharged for power.

### Glossary

Tines, prongs, teeth The tines of a leaf caddy are sometimes called prongs or teeth. There are many different types of tines that may be consistent with a leaf caddy. Depending on what they are designed for, the tines may be long or short, narrow or wide, flexible or rigid, close together or spaced far apart, and squared, rounded or sharp at the end. The teeth may have a tapered profile. In typical examples, rigid, wide, tapered and rounded teeth may protrude from the front of a leaf caddy. A tooth may include a combination of the above characteristics such as a composite combination of a rigid base with a protruding narrow and flexible tine.

### CONCLUSION

Particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising”, “including”, and “having” can be used interchangeably.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

1. An apparatus to clean a surface with debris comprising:
a frame comprising a front face, and an uplifted panel, wherein the uplifted panel entraps the debris scooped up by the apparatus;
at least a first wheel attached to the frame; wherein the apparatus moves upon the first wheel with at least a portion of a weight of the frame, the uplifted panel and the debris supported by the first wheel;
at least a first fork comprising teeth, wherein the first fork is attached to the uplifted panel;
a first adjustment fixture attached to the frame and to the uplifted panel;
wherein the first adjustment fixture holds the first fork at an angle relative to the surface; and
wherein the angle relative to the surface defines a condition which uplifts the teeth attached to the first fork from a yard surface as the apparatus moves across the yard surface.

2. The apparatus of claim 1 wherein the first adjustment fixture attached to the uplifted panel is continuously adjustable, wherein an adjustment of the first adjustment fixture modifies the angle of the first fork relative to the surface.

3. The apparatus of claim 1 wherein a side of a first tooth of the first fork has a tapered profile.

4. The apparatus of claim 3 wherein an end of the first tooth of the first fork has a pointed profile.

5. The apparatus of claim 3 wherein an end of the first tooth of the first fork has a curved profile.

6. The apparatus of claim 5 wherein at least the first tooth has a rolling feature within a body of the first tooth.

7. The apparatus of claim 6 wherein the rolling feature comprises a roughly spherical shaped ball with an axle running through the roughly spherical shaped ball.

8. The apparatus of claim 7 wherein the first tooth of the first fork is separated from a second tooth of the first fork, wherein the first tooth may move upon a second axle within the first fork independently from the second tooth.

9. The apparatus of claim 5 wherein at least the first tooth has a curved shape under a body of the first tooth, wherein the curved shape under the body of the first tooth facilitates movement across the yard surface by sliding.

10. The apparatus of claim 9 wherein the first tooth of the first fork is separated from a second tooth of the first fork, wherein the first tooth may move upon an axle within the first fork independently from the second tooth.

11. The apparatus of claim 3 further comprising a second adjustment fixture, wherein the second adjustment fixture adjusts a spacing of at least the first wheel from the frame.

12. The apparatus of claim 11 further comprising a second wheel, a third wheel and a fourth wheel, wherein the second adjustment fixture adjusts a second spacing of all of the first wheel, the second wheel, the third wheel and the fourth wheel from the frame, wherein adjustment of the second spacing changes an elevation of the frame over the yard surface.

13. The apparatus of claim 11 further comprising a handle to facilitate a user to push the apparatus over the yard surface.

14. The apparatus of claim 11 further comprising a first motor, wherein at least the first motor provides power to at least the first wheel to facilitate moving the apparatus over the yard surface.

15. The apparatus of claim 14 further comprising a battery.

16. The apparatus of claim 15 further comprising a combustion engine.

17. The apparatus of claim 15 further comprising a computer processor, a touch screen interface, and a communication system.

18. The apparatus of claim 3 further comprising a connection mount, wherein the connection mount connects the apparatus of claim 3 to a motorized frame.

19. A method of cleaning a debris from a surface, the method comprising:
placing an apparatus to clean the surface of the debris upon a yard surface, wherein the apparatus to clean the surface of the debris comprises:
a frame comprising a front face, and an uplifted panel, wherein the uplifted panel entraps debris scooped up by the apparatus, at least a first wheel attached to the frame; wherein the apparatus moves upon the first wheel with at least a portion of a weight of both the frame and the debris supported by the first wheel, at least a first fork comprising teeth, wherein the first fork is attached to a first adjustment fixture, wherein the first adjustment fixture holds the first fork at an angle relative to the yard surface, and wherein the angle relative to the yard surface uplifts the teeth attached to the first fork from the yard surface as the apparatus moves across the yard surface;
adjusting the first adjustment fixture to place the first fork at a different degree of uplift from the yard surface in response to one or more of a length of grass blades, a roughness of the surface, and a nature of the debris upon the yard surface; and
moving the apparatus across the yard surface, wherein the debris is caught into the uplifted panel of the apparatus and moved by the apparatus.

20. A method of cleaning a debris from a surface, the method comprising:
placing an apparatus to clean the surface of the debris upon a yard surface, wherein the apparatus to clean the surface of the debris comprises:
a drive frame, and an uplifted panel, wherein the uplifted panel entraps debris scooped up by the apparatus, at least a first wheel attached to the drive frame; wherein the apparatus moves upon the first wheel with at least a portion of a weight of the drive frame and the debris supported by the first wheel, at least a first fork comprising teeth, wherein the first fork is attached to a first adjustment fixture, wherein the first adjustment fixture holds the first fork at an angle relative to the surface, wherein the angle relative to the yard surface uplifts the teeth attached to the first fork from the yard surface as the apparatus moves across the yard surface, a second adjustment fixture to adjust a spacing between the drive frame and the first wheel, a motor to provide power to the first wheel, a computer processor, a touch screen interface, and a communication system;
adjusting the first adjustment fixture to place the first fork at a different degree of uplift from the yard surface in response to one or more of a length of grass blades, a roughness of the surface, and a nature of the debris upon the yard surface;
adjusting the second adjustment fixture to change the spacing between the first wheel and the drive frame of the apparatus;
communicating parameters to the communication system from an external communication device;
inputting the parameters from the communication system into the computer processor, wherein the parameters are used by the computer processor to determine a path of movement of the apparatus; and
moving the apparatus across the yard surface, wherein the debris is caught into the uplifted panel of the apparatus and moved by the apparatus.
